(19) United States
(12) Patent Application Publication
(10) Pub. No.: US 2026/0095087 A1
(43) Pub. Date: Apr. 2, 2026

(54) DUAL-PHASE DC-DC CONVERTER WITH WIDE INPUT VOLTAGE RANGE AND CONTROL METHOD THEREOF

(71) Applicant: Hangzhou MPS Semiconductor Technology, Ltd., Hangzhou (CN)

(72) Inventor: Lei Du, Hangzhou (TW)

(21) Appl. No.: 19/344,000

(22) Filed: Sep. 29, 2025

(30) Foreign Application Priority Data
Sep. 30, 2024 (CN) 202411379914.3

(51) Int. Cl. H02M 1/00; H02M 3/158

(52) U.S. Cl. CPC H02M 1/0025; H02M 3/1582

(57) ABSTRACT

A control circuit for a DC-DC converter includes a first and second error amplifying circuit, a control voltage generator and a pulse width modulation circuit. The first error amplifying circuit provides a first error amplifying signal based upon an output feedback signal representative of an output voltage and an output reference signal. The second error amplifying circuit provides a second error amplifying signal based upon the first error amplifying signal and a current sense signal representative of a sum of a first current flowing through a first inductor and a second current flowing through a second inductor. The control voltage generator provides a control voltage based upon the second error amplifying signal and a reference voltage. Based on an input voltage, the output voltage and the control voltage, the pulse width modulation circuit controls a first-leg portion to third-leg portion of the DC-DC converter, respectively.

### CROSS-REFERENCE TO RELATED APPLICATIONS

This application claims the benefit of CN application 202411379914.3, filed on Sep 30, 2024, and incorporated herein by reference.

### TECHNICAL FIELD

The present invention generally relates to electronic circuits, and more particularly but not exclusively, to dual-phase DC-DC converters with wide input voltage range and associated methods.

### BACKGROUND

Buck-boost DC-DC converters can convert an input voltage into an output voltage higher than, equal to or lower than the input voltage and can generally be operated with wide input voltage range. With the development of electronic technology, a buck-boost DC-DC converter is widely used in power management applications. From handheld electronic devices such as, a tablet personal computer, an e-book, a digital camera, to large electronic devices such as, a server, a computing base station and so on, all require the buck-boost converter, to meet a demand of wide input voltage range.

### SUMMARY

There has been provided, in accordance with an embodiment of the present disclosure, a DC-DC converter. The DC-DC converter includes a first-leg portion, a second-leg portion, a third-leg portion, a first error amplifying circuit, a second error amplifying circuit, a control voltage generator and a pulse width modulation circuit. The first-leg portion has a first-leg node configured to be coupled to a first terminal of a first inductor. The second-leg portion has a second-leg node configured to be coupled to a second terminal of the first inductor and a first terminal of a second inductor. The third-leg portion has a third-leg node configured to be coupled to a second terminal of the second inductor. The first error amplifying circuit is configured to receive an output feedback signal representative of an output voltage of the DC-DC converter and to provide a first error amplifying signal based upon the output feedback signal and an output reference signal. The second error amplifying circuit is configured to receive the first error amplifying signal and a current sense signal and to provide a second error amplifying signal based upon the first error amplifying signal and the current sense signal. The current sense signal is representative of a sum of a first current flowing through the first inductor and a second current flowing through the second inductor. The control voltage generator is configured to provide a control voltage based upon the second error amplifying signal and a reference voltage. The pulse width modulation circuit is configured to respectively control the first-leg portion, the second-leg portion, and the third-leg portion, based upon an input voltage, the output voltage and the control voltage.

There has also been provided, in accordance with an embodiment of the present disclosure, a control circuit for a DC-DC converter. The control circuit comprises a first error amplifying circuit, a second error amplifying circuit, a control voltage generator and a pulse width modulation circuit. The first error amplifying circuit is configured to receive an output feedback signal representative of an output voltage of the DC-DC converter and to provide a first error amplifying signal based upon the output feedback signal and an output reference signal. The second error amplifying circuit is configured to receive the first error amplifying signal and a current sense signal and to provide a second error amplifying signal based upon the first error amplifying signal and the current sense signal. The current sense signal is representative of a sum of a first current flowing through a first inductor of the DC-DC converter and a second current flowing through a second inductor of the DC-DC converter. The control voltage generator is configured to provide a control voltage based upon the second error amplifying signal and a reference voltage. The pulse width modulation circuit is configured to control a first-leg portion, a second-leg portion, and a third-leg portion of the DC-DC converter, respectively, based upon an input voltage, the output voltage and the control voltage.

There has also been provided, in accordance with an embodiment of the present disclosure, a control method used in a DC-DC converter. The method comprises the following steps. A first error amplifying signal is provided based upon an output feedback signal representative of an output voltage of the DC-DC converter and an output reference signal. A current sense signal is representative of a sum of a first current flowing through a first inductor of the DC-DC converter and a second current flowing through a second inductor of the DC-DC converter A second error amplifying signal is provided based upon the first error amplifying signal and the current sense signal. A control voltage is provided based upon the second error amplifying signal and a reference voltage. A first-leg portion, a second-leg portion and a third-leg portion of the DC-DC converter are respectively controlled based upon an input voltage, the output voltage and the control voltage.

### BRIEF DESCRIPTION OF DRAWINGS

The present invention can be further understood with reference to the following detailed description and the appended drawings, wherein like elements are provided with like reference numerals.

FIG. 1 shows a block diagram of an electronic device 100 in accordance with an embodiment of the present invention.

FIG. 2 shows a schematic diagram of a DC-DC converter 10A in accordance with an embodiment of the present invention.

FIG. 3 shows partial circuit diagram of the control circuit 104B in accordance with an embodiment of the present invention.

FIG. 4 shows a pulse width modulation circuit 44A in accordance with an embodiment of the present invention.

FIG. 5a~5e respectively show working waveforms of the pulse width modulation circuit 44A in accordance with a respective embodiment of the present invention.

FIG. 6 shows working waveform of the DC-DC converter 10A shown in FIG. 2 in accordance with an embodiment of the present invention.

FIG. 7 shows a zoom-in view of the working waveforms during a period from A to B shown in FIG. 6 in accordance with an embodiment of the present invention.

FIG. 8 shows partial circuit diagram of the control circuit 104C in accordance with an embodiment of the present invention.

FIG. 9a and 9b respectively show working waveforms of the DC-DC converter without and with a controlled current source 55 in accordance with an embodiment of the present invention.

FIG. 10 shows a flow diagram of a control method 600 used in a DC-DC converter in accordance with an embodiment of the present invention.

FIG. 11 shows a flow diagram of a step 605 shown in FIG. 10 in accordance with an embodiment of the present invention.

### DETAILED DESCRIPTION OF THE INVENTION

Reference will now be made in detail to the preferred embodiments of the invention, examples of which are illustrated in the accompanying drawings. While the invention will be described in conjunction with the preferred embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following detailed description of the present invention, numerous specific details are set forth in order to provide a thorough understanding of the present invention. However, it will be obvious to one of ordinary skill in the art that the present invention may be practiced without these specific details. In other instances, well-known methods, procedures, components, and circuits have not been described in detail so as not to unnecessarily obscure aspects of the present invention.

Reference to "one embodiment", "an embodiment", "an example" or "examples" means: certain features, structures, or characteristics are contained in at least one embodiment of the present invention. These "one embodiment", "an embodiment", "an example" and "examples" are not necessarily directed to the same embodiment or example. Furthermore, the features, structures, or characteristics may be combined in one or more embodiments or examples. In addition, it should be noted that the drawings are provided for illustration, and are not necessarily to scale. And when an element is described as "connected" or "coupled" to another element, it can be directly connected or coupled to the other element, or there could exist one or more intermediate elements. In contrast, when an element is referred to as "directly connected" or “directly coupled” to another element, there is no intermediate element.

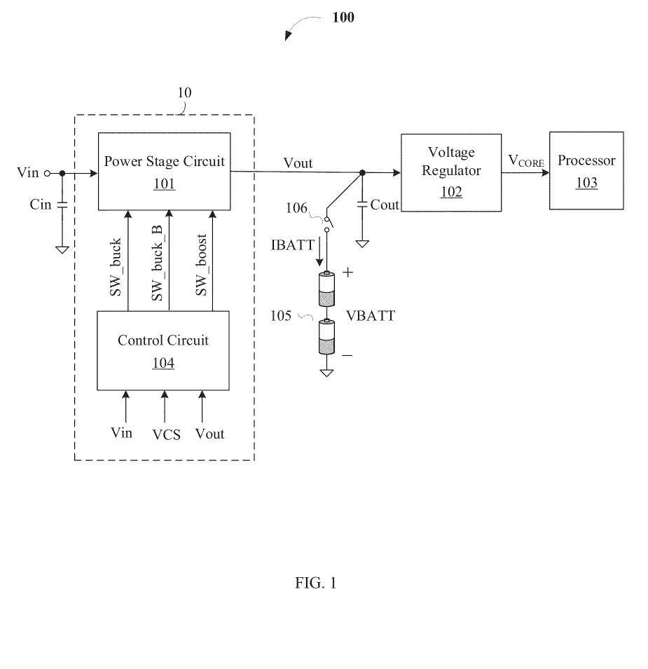

FIG. 1 shows a schematic diagram of an electronic device 100 in accordance with an embodiment of the present invention. The electronic device 100 comprises a DC-DC converter 10, a voltage regulator (VR) 102, and a processor 103. The DC-DC converter 10 comprises a power stage circuit 101 and a control circuit 104. The processor 103 may be a central processing unit (CPU), a graphics processing unit (GPU) or an application specific integrated circuit (ASIC). In one embodiment, the electronic device 100 is part of a computing platform. The DC-DC converter 10, a battery 105 and the voltage regulator 102 are configured to provide power to the computing platform. In detail, the DC-DC converter 10 and/or the battery 105 may provide an output voltage Vout for the computing platform, the voltage regulator 102 converts the output voltage Vout to a processor voltage V_{CORE} to the processor 103.

As shown in FIG. 1, the power stage circuit 101 has an input terminal to receive an input voltage Vin and an output terminal to provide the output voltage Vout. Based on the input voltage Vin, the output voltage Vout and a current sense signal VCS representative of a current flowing through an energy storge device (e.g., inductor) of the power stage circuit 101, the control circuit 104 respectively provides a first pulse width modulation signal SW_buck, a second pulse width modulation signal SW_boost, and a third pulse width modulation signal SW_buck_B, to control power switches of the power stage circuit 101. In one embodiment, the power stage circuit 101 and a switch 106 could be configured as a narrow voltage direct current (NVDC) battery charging circuit. When the power stage circuit 101 is connected to an external power supply, for example, an external AC power supply adapter or an external USB port, the external power supply provides the output voltage Vout via the power stage circuit 101, and provides a charging current IBATT to charge the battery 105 via the switch 106.

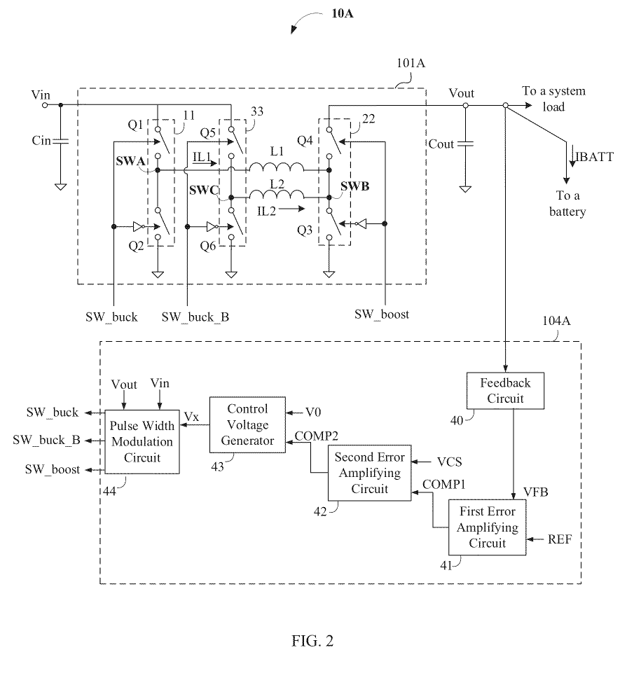

FIG. 2 shows a DC-DC converter 10A in accordance with an embodiment of the present invention. As shown in FIG. 2, the power stage circuit 101A is a dual-phase buck-boost converter. The power stage circuit 101A comprises switches Q1~Q6 and inductors L1 and L2. An input capacitor Cin is coupled between an input terminal and a reference ground, an output capacitor Cout is coupled between an output terminal and the reference ground. In one embodiment, the power stage circuit 101A is configured to provide the output voltage Vout to a system load (e.g., a voltage regulator 102 and/or a processor 103 as shown in FIG. 1), as well as to provide a charging current IBATT to charge a battery.

As shown in FIG. 2, a first-leg portion 11 of the DC-DC converter 10 comprises a high-side switch Q1 and a low-side switch Q2 coupled in series between an input voltage Vin and the reference ground. The high-side switch Q1 and the low-side switch Q2 may work complementarily, a first-leg node SWA of the first-leg portion 11 is selectively coupled to one of the input voltage Vin and the reference ground, under the control of the first pulse width modulation signal SW_buck. The first-leg node SWA is coupled to a first terminal of the inductor L1.

A second-leg portion 22 of the DC-DC converter 10 comprises a high-side switch Q4 and a low-side switch Q3 coupled in series between the output voltage Vout and the reference ground. The low-side switch Q3 and the high-side switch Q4 may work complementarily, and a second-leg node SWB of the second-leg portion 22 is selectively coupled to one of the output voltage Vout and the reference ground, under the control of the second pulse width modulation signal SW_boost. The second-leg node SWB is coupled to a second terminal of the inductor L1 and a first terminal of the inductor L2.

A third-leg portion 33 of the DC-DC converter 10 comprises a high-side switch Q5 and a low-side switch Q6 coupled in series between the input voltage Vin and the reference ground. The high-side switch Q5 and the low-side switch Q6 may work complementarily, and a third-leg node SWC of the third-leg portion 33 is selectively coupled to one of the input voltage Vin and the reference ground, under the control of the third pulse width modulation signal SW_buck_B. The third-leg node SWC is coupled to a second terminal of the inductor L2.

The switches Q1~Q6 may be any controllable semiconductor devices, such as MOSFET (metal oxide semiconductor field effect transistor), IGBT (isolated gate bipolar transistor), SiC (Silicon Carbide), GaN (Gallium Nitride) and so on.

In the embodiment shown in FIG. 2, the control circuit 104A comprises a feedback circuit 40, a first error amplifying circuit 41, a second error amplifying circuit 42, a control voltage generator 43, and a pulse width modulation circuit 44. As shown in FIG. 2, the feedback circuit 40 has an input terminal coupled to the output terminal of the power stage circuit 101A to receive the output voltage Vout, and has an output terminal to provide an output feedback signal VFB representative of the output voltage Vout. In one embodiment, the feedback circuit 40 may simply comprise a buffer or a conductor or the like, so that the output feedback signal VFB has substantially the same voltage level as the output voltage Vout. In another embodiment, the feedback circuit 40 may include a voltage divider or the like in which the output feedback signal VFB is proportional to the output voltage Vout.

Referring still to FIG. 2, the first error amplifying circuit 41 has a first input terminal, a second input terminal and an output terminal. The first input terminal of the first error amplifying circuit 41 receives the output feedback signal VFB, the second input terminal of the first error amplifying circuit 41 receives an output reference signal REF. The first error amplifying circuit 41 amplifies a difference between the output feedback signal VFB and the output reference signal REF and provides a first error amplifying signal COMP1 at the output terminal. The output reference signal REF may indicate a target voltage level of the output voltage Vout. In one embodiment, the first error amplifying circuit 41 may provide some loop compensation at the output terminal to keep the output feedback signal VFB at a level equal to the output reference signal REF.

The first error amplifying signal COMP1 is provided to a first input terminal of the second error amplifying circuit 42. A second input terminal of the second error amplifying circuit 42 receives a current sense signal VCS. The current sense signal VCS is representative of a sum of a first current IL1 flowing through the inductor L1 and a second current IL2 flowing through the inductor L2. The second error amplifying circuit 42 amplifies a difference between the first error amplifying signal COMP1 and the current sense signal VCS and provides a second error amplifying signal COMP2 at an output terminal. In one embodiment, the second error amplifying circuit 42 may provide some loop compensation at the output terminal to keep the current sense signal VCS at a level equal to the first error amplifying signal COMP1.

In one embodiment, the DC-DC converter 10A further comprise a current sense circuit (not shown), to provide the current sense signal VCS. The current sense circuit may comprise a sensing resistor coupled in series with the inductor L1 to provide the first current IL1 and another sensing resistor coupled in series with the inductor L2 to provide the second current IL2, and provide the current sense signal VCS by summing the first current IL1 and the second current IL2. Alternatively, internal resistance (RDSON) between drain and source of each of the power switches (Q1~Q6) can be used to detect the voltage drop across each power switch, to provide the current sense signal VCS based thereupon.

In the embodiment shown in FIG. 2, the control voltage generator 43 has a first input terminal, a second input terminal and an output terminal. The first input terminal of the control voltage generator 43 receives the second error amplifying signal COMP2, the second input terminal of the control voltage generator 43 receives a reference voltage V0. Based on a voltage difference between the second error amplifying signal COMP2 and the reference voltage V0, the control voltage generator 43 provides a control voltage Vx at the output terminal. In one embodiment, the reference voltage V0 is a constant voltage level, such as 1V.

The pulse width modulation circuit 44 is configured to provide the first pulse width modulation signal SW_buck, the second pulse width modulation signal SW_boost and the third pulse width modulation signal SW_buck_B, based upon the input voltage Vin, the output voltage Vout and the control voltage Vx. The first pulse width modulation signal SW_buck is used to control the first-leg portion 11, for selectively coupling the first-leg node SWA to the input voltage Vin or the reference ground. The second pulse width modulation signal SW_boost is used to control the second switch-leg portion 22, for selectively coupling the second-leg node SWB to the output voltage Vout or the reference ground. Furthermore, the third pulse width modulation signal SW_buck_B is used to control the third-leg portion 33, for selectively coupling the third-leg node SWC to the input voltage Vin or the reference ground, based upon the input voltage Vin.

In one embodiment, the control circuit 104B further comprises a first to third driver. The first driver comprises a non-inverting driving circuit and an inverting driving circuit to control the switches Q1 and Q2 of the first-leg portion 11, and these driving circuits are both controlled or activated by the first pulse width modulation signal SW_buck. The second driver comprises a non-inverting driving circuit and an inverting driving circuit to control the switches Q4 and Q3 of the second-leg portion 22, and these driving circuits are both controlled or activated by the second pulse width modulation signal SW_boost. The third driver comprises a non-inverting driving circuit and an inverting driving circuit to control the switches Q5 and Q6 of the third-leg portion 33, and these driving circuits are both controlled or activated by the third pulse width modulation signal SW_buck_B. In applications, the switches Q1 and Q2 can work complementarily, the switches Q4 and Q3 can work complementarily, and the switches Q5 and Q6 can work complementarily.

In one embodiment, when the second pulse width modulation signal SW_boost is kept at a constant voltage level (e.g., a logic high), during a switching cycle, the high-side switch Q1 is maintained on and the low-side switch Q2 is maintained off in response to the first pulse width modulation signal SW_buck being logic high, the high-side switch Q1 is turned off and the low-side switch Q2 is turned on in response to the first pulse width modulation signal SW_buck being logic low.

In one embodiment, when the first pulse width modulation signal SW_buck is kept at a constant voltage level (e.g., logic high), during a switching cycle, the high-side switch Q4 is maintained on and the low-side switch Q3 is maintained off in response to the second pulse width modulation signal SW_boost being logic high. The high-side switch Q4 is turned off and the low-side switch Q3 is turned on in response to the second pulse width modulation signal SW_boost being logic low.

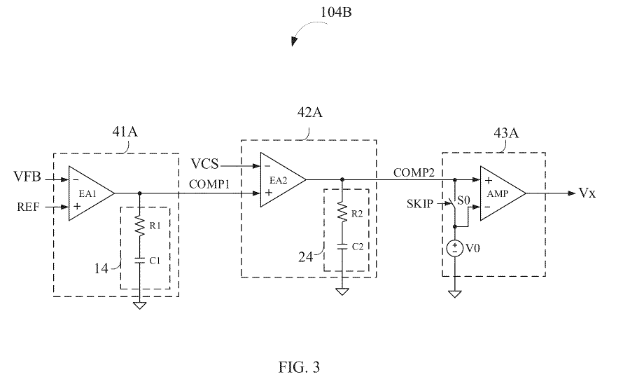

FIG. 3 shows partial circuit diagram of the control circuit 104B in accordance with an embodiment of the present invention. As shown in FIG. 3, the first error amplifying circuit 41A comprises an error amplifier EA1 and a compensation circuit 14. A non-inverting input terminal of the error amplifier EA1 receives the output reference signal REF. An inverting input terminal of the error amplifier EA1 receives the output feedback signal VFB. The compensation circuit 14 is coupled to an output terminal of the error amplifier EA1 to provide the loop compensation. In one example, the compensation circuit 14 comprises a compensation resistor R1 and a compensation capacitor C1 and performs a PI compensation to proportionally integrate an output signal of the error amplifier EA1 to provide the first error amplifying signal COMP1. In another embodiment, the compensation circuit 14 may perform other type of compensation.

In the embodiment shown in FIG. 3, the second error amplifying circuit 42A comprises an error amplifier EA2 and a compensation circuit 24. A non-inverting input terminal of the error amplifier EA2 is coupled to the output terminal of the first error amplifying circuit 41A to receive the first error amplifying signal COMP1. An inverting input terminal of the error amplifier EA2 receives the current sense signal VCS. The compensation circuit 24 is coupled to an output terminal of the error amplifier EA2 to provide the loop compensation. In one example, the compensation circuit 24 comprises a compensation resistor R2 and a compensation capacitor C2 and performs a PI compensation to proportionally integrate an output signal of the error amplifier EA2 to provide the second error amplifying signal COMP2. In another embodiment, the compensation circuit 24 may perform other type of compensation.

The control voltage generator 43A has a first input terminal to receive the second error amplifying signal COMP2 and a second input terminal to receive the reference voltage V0, and is configured to provide the control voltage Vx based upon a voltage difference between the second error amplifying signal COMP2 and the reference voltage V0. In one embodiment, the control voltage generator 43A comprises a voltage-controlled voltage source configured to generate the control voltage Vx proportional to the voltage difference.

In one embodiment, the control voltage generator 43A comprises an operational amplifier AMP. A non-inverting input terminal of the operational amplifier AMP receives the second error amplifying signal COMP2. An inverting input terminal of the operational amplifier AMP is coupled to a positive terminal of a reference voltage source to receive the reference voltage V0. A negative terminal of the reference voltage source is coupled to the reference ground. The operational amplifier AMP provides the control voltage Vx based upon the voltage difference between the second error amplifying signal COMP2 and the reference voltage V0. In an example, the control voltage Vx is positive value. In another embodiment, the control voltage Vx may be negative value.

In a further embodiment, the control voltage generator 43A further comprises a control switch S0. The control switch S0 is coupled between the first input terminal and the second input terminal of the control voltage generator 43A and is controlled by a clamp control signal SKIP. The control switch S0 is turned on when the clamp control signal SKIP indicates that the first error amplifying signal COMP1 is less than a first threshold voltage. At this time, the non-inverting input terminal and the inverting input terminal of the operational amplifier AMP are coupled together and the control voltage Vx becomes 0. The first pulse width modulation signal SW_buck, the second modulation signal SW_boost and the third pulse width modulation signal SW_buck_B are paused and the switches Q1-Q6 are all turned off. The control switch S0 is turned off when the clamp control signal SKIP indicates that the first error amplifying signal COMP1 is higher than the first threshold voltage. Based on the voltage difference between the second error amplifying signal COMP2 and the reference voltage V0, the control voltage generator 43A provides the control voltage Vx that changes from 0.

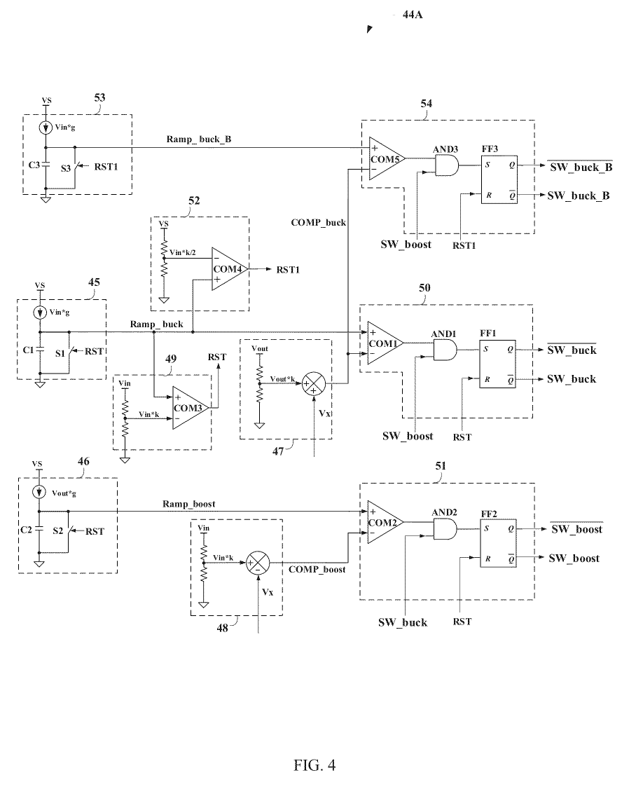

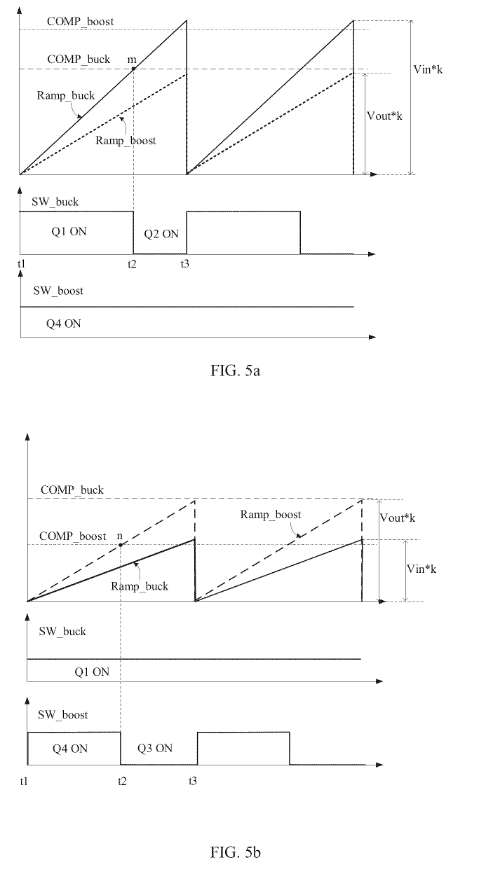

FIG. 4 shows a pulse width modulation circuit 44A in accordance with an embodiment of the present invention. As shown in FIG. 4, the pulse width modulation circuit 44A comprises a first ramp signal generator 45, a second ramp signal generator 46, a first modulation signal generator 47, a second modulation signal generator 48, a switching cycle control circuit 49, a first modulation circuit 50 and a second modulation circuit 51.

In the example shown in FIG. 4, the first ramp signal generator 45 is configured to provide a first ramp signal Ramp_buck. A rising slope of the first ramp signal Ramp_buck is in a first proportion to the input voltage Vin. The second ramp signal generator 46 is configured to provide a second ramp signal Ramp_boost. A rising slope of the second ramp signal Ramp_boost is in the first proportion to the output voltage Vout.

Referring still to FIG. 4, the first modulation signal generator 47 comprises an adder circuit, to provide a first modulation signal COMP_buck by adding the control voltage Vx to a first voltage dividing signal (e.g., Vout*k). The first voltage dividing signal Vout*k is representative of the output voltage Vout. The second modulation signal generator 48 comprises a subtracter to provide a second modulation signal COMP_boost by subtracting the control voltage Vx from a second voltage dividing signal (e.g., Vin*k). The second voltage dividing signal Vin*k is representative of the input voltage Vin.

The switching cycle control circuit 49 is configured to compare the first ramp signal Ramp_buck with the second voltage dividing signal Vin*k and to provide a switching cycle control signal RST, to determine the switching cycle of the first pulse width modulation signal SW_buck or the second pulse width modulation signal SW_boost. In one embodiment, the switching cycle control signal RST has a first type transition edge and a second type transition edge in each switching cycle. In one embodiment, the switching cycle control circuit 49 provides the switching cycle control signal RST with the first type transition edge (e.g., a rising edge) when the first ramp signal Ramp_buck increases to the second voltage dividing signal Vin*k.

In the embodiment shown in FIG. 4, the first ramp signal Ramp_buck, the second ramp signal Ramp_boost and the switching cycle control signal RST are in phase. In the embodiment shown in FIG. 4, the switching cycle control circuit 49 comprises a comparator COM3. A non-inverting input terminal of the comparator COM3 receives the first ramp signal Ramp_buck. An inverting input terminal of the comparator COM3 receives the second voltage dividing signal Vin*k, and an output terminal of the comparator COM3 provides the switching cycle control signal RST. In another embodiment, the switching cycle control circuit 443 comprises a timer circuit, to determine the switching cycle based on the input voltage Vin.

The first modulation circuit 50 has a first input terminal to receive the switching cycle control signal RST, a second input terminal to receive the first ramp signal Ramp_buck, a third input terminal to receive the first modulation signal COMP_buck, a fourth input terminal to receive the second pulse width modulation signal SW_boost. The first modulation circuit 50 is configured to provide the first pulse width modulation signal SW_buck based upon the first ramp signal Ramp_buck, the first modulation signal COMP_buck, the switching cycle control signal RST and the second pulse width modulation signal SW_boost. In detail, when the switching cycle control signal RST is activated, the first pulse width modulation signal SW_buck becomes a first logic state (e.g., logic high), the high-side switch Q1 is turned on, the first-leg node SWA of the first-leg portion 11 is coupled to the input voltage Vin. In response to the second pulse width modulation signal SW_boost being the first logic state (e.g., logic high) and the first ramp signal Ramp_buck increasing to the first modulation signal COMP_buck, the low-side switch Q2 is turned on, the first-leg node SWA is disconnected from the input voltage Vin and is coupled to the reference ground.

In the example shown in FIG. 4, the first modulation circuit 50 comprises a comparator COM1, a first AND gate circuit AND1 and a trigger circuit FF1. As shown in FIG. 4, a non-inverting input terminal of the comparator COM1 receives the first ramp signal Ramp_buck. An inverting input terminal of the comparator COM1 receives the first modulation signal COMP_buck, and an output terminal of the comparator COM1 provides a first comparison signal. The first AND gate circuit AND1 has a first input terminal to receive the first comparison signal, a second input terminal to receive the second pulse width modulation signal SW_boost and an output terminal. The first trigger circuit FF1 has a set terminal, a reset terminal, an output terminal and an inverting output terminal, wherein the set terminal is coupled to the output terminal of the first AND gate circuit AND1, the reset terminal is configured to receive the switching cycle control signal RST. The first trigger circuit FF1 is configured to provide the first pulse width modulation signal SW_buck at the inverting output terminal, to provide an inverting signal of the first pulse width modulation signal SW_buck at the output terminal, for controlling the high-side switch Q1 and the low-side switch Q2 to work complementarily.

In the example shown in FIG. 4, the second modulation circuit 51 has a first input terminal to receive the switching cycle control signal RST, a second input terminal to receive the second ramp signal Ramp_boost, a third input terminal to receive the second modulation signal COMP_boost, a fourth input terminal to receive the first pulse width modulation signal SW_buck. The second modulation circuit 51 is configured to provide the second pulse width modulation signal SW_boost based upon the second ramp signal Ramp_boost, the second modulation signal COMP_boost, the switching cycle control signal RST and the first pulse width modulation signal SW_buck. In detail, when the switching cycle control signal RST is activated, the second pulse width modulation signal SW_boost becomes the first logic state (e.g., logic high), the high-side switch Q4 is turned on, the second-leg node SWB of the second-leg portion 22 is coupled to the output voltage Vout. In response to the first pulse width modulation signal SW_buck being the first logic state (e.g., logic high) and the second ramp signal Ramp_boost increasing to the second modulation signal COMP_boost, the low-side switch Q3 is turned on, the first-leg node SWA is disconnected from the input voltage Vin and is coupled to the reference ground.

Similarly, the second modulation circuit 51 comprises a comparator COM2, a second AND gate circuit AND2 and a trigger circuit FF2. As shown in FIG. 4, a non-inverting input terminal of the comparator COM2 receives the second ramp signal Ramp_boost. An inverting input terminal of the comparator COM2 receives the second modulation signal COMP_boost, and an output terminal of the comparator COM2 provides a second comparison signal. The second AND gate circuit AND2 has a first input terminal to receive the second comparison signal, a second input terminal to receive the first pulse width modulation signal SW_buck and an output terminal. The second trigger circuit FF2 has a set terminal, a reset terminal, an output terminal and an inverting output terminal, wherein the set terminal is coupled to the output terminal of the second AND gate circuit AND2, the reset terminal is configured to receive the switching cycle control signal RST. The second trigger circuit FF2 is configured to provide the second pulse width modulation signal SW_boost at the inverting output terminal, to provide an inverting signal of the second pulse width modulation signal SW_boost at the output terminal, for controlling the high-side switch Q3 and the low-side switch Q3 to work complementarily.

In an example, a first ramp signal generator 45 comprises a first current source, a first capacitor C1 and a first discharge switch S1. The first current source is coupled to a power supply VS and provides a first charging current Vin*g to charge the first capacitor C1. The first ramp signal Ramp_buck increases from 0. In response to a rising edge of the switching cycle control signal RST, the first discharge switch S1 is turned on for discharging the first capacitor C1, to reset the first ramp signal Ramp_buck to 0. The second ramp signal generator 46 comprises a second current source, a second capacitor C2, and a second discharge switch S2. The second current source is coupled to the power supply VS and provides a second charging current Vout*g to charge the second capacitor C2. The second ramp signal Ramp_boost increases from 0. In response to the rising edge of the switching cycle control signal RST, the second discharge switch S2 is turned on for discharging the second capacitor C2, to reset the second ramp signal Ramp_boost to 0.

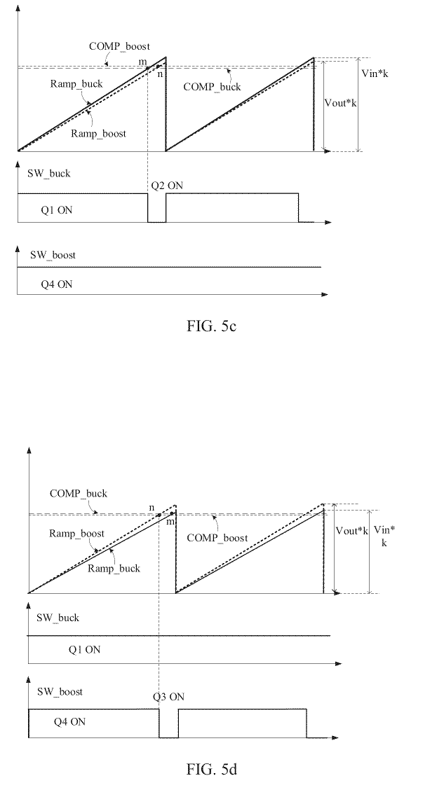

FIG. 5a-5e respectively show working waveforms of the pulse width modulation circuit 44A in accordance with a respective embodiment of the present invention. Several details of the embodiments will be described below with reference to FIGS. 5a-5e.

In the embodiment shown in FIG. 5a, the input voltage Vin is higher than the output voltage Vout. The first modulation signal COMP_buck is less than the second modulation signal COMP_boost. The rising slope of the first ramp signal Ramp_buck is also higher than that of the second ramp signal Ramp_boost. From time t1, the first ramp signal Ramp_buck and the second ramp signal Ramp_boost both increase from zero. The switching cycle control signal RST provided by the switching cycle control circuit 49 shown in FIG. 4 keeps logic low. The first pulse width modulation signal SW_buck and the second pulse width modulation signal SW_boost both keep logic high, and thus the high-side switch Q1 and the high-side switch Q4 are turned on, the low-side switch Q2 and the low-side switch Q3 are kept off.

At time t2, the first ramp signal Ramp_buck increases to reach the first modulation signal COMP_buck, as a point m shown in FIG. 5a. The second pulse width modulation signal SW_boost is still the logic high, the high-side switch Q4 is maintained on and the low-side switch Q3 is maintained off. The first pulse width modulation signal SW_buck becomes logic low, the low-side switch Q2 is turned on and the high-side switch Q1 is turned off.

At time t3, the first ramp signal Ramp_buck increases to reach the second voltage dividing signal Vin*k, and the current switching cycle is over. The first ramp signal Ramp_buck and the second ramp signal Ramp_boost are both reset to zero. From time t3, a new switching cycle starts.

In the embodiment shown in FIG. 5b, the input voltage Vin is less than the output voltage Vout. The first modulation signal COMP_buck is higher than the second modulation signal COMP_boost. The rising slope of the first ramp signal Ramp_buck is also less than the one of the second ramp signal Ramp_boost. As shown in FIG. 5b, from time t1, the first ramp signal Ramp_buck and the second ramp signal Ramp_boost both increase from zero. The first pulse width modulation signal SW_buck and the second pulse width modulation signal SW_boost both keep logic high, and thus the high-side switch Q1 and the high-side switch Q4 are turned on, the low-side switch Q2 and the low-side switch Q3 are turned off.

At time t2, the second ramp signal Ramp_boost is the first to increase to reach the second modulation signal COMP_boost, as a point n shown in FIG. 5b. The first pulse width modulation signal SW_buck is still logic high, the high-side switch Q1 is maintained on and the low-side switch Q2 is maintained off. The second pulse width modulation signal SW_boost becomes logic low, the low-side switch Q3 is turned on and the high-side switch Q4 is turned off.

At time t3, the second ramp signal Ramp_boost increases to reach the first voltage dividing signal Vout*k, and the current switching cycle is over. The first ramp signal Ramp_buck and the second ramp signal Ramp_boost are both reset to zero by the switching cycle control signal RST. From time t3, a new switching cycle starts.

In the embodiment shown in FIG. 5c, the input voltage Vin is slightly higher than the output voltage Vout. The first modulation signal COMP_buck is slightly less than the second modulation signal COMP_boost. The rising slope of the first ramp signal Ramp_buck is also approaching the one of the second ramp signal Ramp_boost.

The first ramp signal Ramp_buck increases to reach the first modulation signal COMP_buck, as the point m shown in FIG. 5c, which is slightly earlier than the time when the second ramp signal Ramp_boost increases to reach the second modulation signal COMP_boost, as the point n shown in FIG. 5c. Compared with FIG. 5a, the first pulse width modulation signal SW_buck shown in FIG. 5c has a higher duty cycle.

In the embodiment shown in FIG. 5d, the input voltage Vin is slightly less than the output voltage Vout. The first modulation signal COMP_buck is slightly higher than the second modulation signal COMP_boost. The time when the first ramp signal Ramp_buck increases to the first modulation signal COMP_buck (as the point m shown in FIG. 5d), is slightly later than the time when the second ramp signal Ramp_boost increases to the second modulation signal COMP_boost (as the point n shown in FIG. 5d). Compared with FIG. 5b, the second pulse width modulation signal SW_boost shown in FIG. 5d has a higher duty cycle.

Referring still to FIG. 4, the pulse width modulation circuit 44A further comprises a phase shift control circuit 52, a third ramp signal generator 53 and a third modulation circuit 54.

The phase shift control circuit 52 is configured to provide a phase shift control signal RST1 that is 180º out of phase with the switching cycle control signal RST. As shown in FIG. 4, the phase shift control circuit 52 comprises a comparator COM4. The comparator COM4 compares half of the second voltage dividing signal Vin*k with the first ramp signal Ramp_buck, and provides the phase shift control signal RST1 at an output terminal. In other embodiments, the phase shift control circuit 52 may have other circuit structure.

The third ramp signal generator 53 is configured to provide a third ramp signal Ramp_buck_B that is 180º out of phase with the first ramp signal Ramp_buck. As shown in FIG. 4, the third ramp signal Ramp_buck_B comprises a third current source, a third capacitor C3 and a third discharge switch S3. The third current source is coupled to the power supply VS and provides the first charging current Vin*g to charge the third capacitor C3. The third ramp signal Ramp_buck_B increases from 0. In response to a rising edge of the phase shift control signal RST1, the third discharge switch S3 is turned on for discharging the third capacitor C3, to reset the third ramp signal Ramp_buck_B to 0.

The third modulation circuit 54 operates generally similarly as the first modulation circuit 50. As a result, the operation of the third modulation circuit 54 is omitted for clarity. The third modulation circuit 54 is configured to provide the third pulse width modulation signal SW_buck_B based upon the third ramp signal Ramp_buck_B, the first modulation signal COMP_buck, the phase shift control signal RST1 and the second pulse width modulation signal SW_boost. In detail, when the phase shift control signal RST1 is activated when the rising edge comes, the third pulse width modulation signal SW_buck_B becomes the first logic state (e.g., logic high), the high-side switch Q5 is turned on, the third-leg node SWC of the first-leg portion 33 is coupled to the input voltage Vin. In response to the second pulse width modulation signal SW_boost being the first logic state (e.g., logic high) and the third ramp signal Ramp_buck_B increasing to the first modulation signal COMP_buck, the low-side switch Q6 is turned on, the third-leg node SWC is disconnected from the input voltage Vin and is coupled to the reference ground. In the example shown in FIG. 4, the third modulation circuit 54 comprises a comparator COM5, a third AND gate circuit AND3 and a third trigger circuit FF3.

In the embodiment shown in FIG. 5e, from time t1, both the first ramp signal Ramp_buck and the second ramp signal Ramp_boost increase from zero, the first pulse width modulation signal SW_buck and the second pulse width modulation signal SW_boost are both kept logic high, and the high-side switches Q1 and Q4 are turned on and the low-side switches Q2 and Q3 are kept off.

At time t1B, the third ramp signal Ramp_buck_B increases from zero, the phase shift control signal RST1 provided by the phase shift control circuit 52 is kept logic low, the third pulse width modulation signal SW_buck_B is kept logic high, the high side switch Q5 is turned on and the low side switch Q6 is turned off.

At time t2, the first ramp signal Ramp_buck increases to the first modulation signal COMP_buck, as the point m shown in FIG. 5e. Until time t3, the first ramp signal Ramp_buck increases to reach the second voltage dividing signal Vin*k, the rising edge of the switching cycle control signal RST comes, the first ramp signal Ramp_buck and the second ramp signal Ramp_boost both reset to zero.

At time t2B, the third ramp signal Ramp_buck_B increases to the first modulation signal COMP_buck, as a point m1 shown in FIG. 5e. Until time t3B, the third ramp signal Ramp_buck_B increases to reach the second voltage dividing signal Vin*k, the third ramp signal Ramp_buck_B resets to zero. The third ramp signal Ramp_buck_B and the phase shift control signal RST1 are in phase.

Those skilled in the art should understand that circuits in the control circuit may not be limited to the specific embodiments shown in FIG. 2~4. For example, the non-inverting terminal and inverting terminal of a comparator can be interchangeable to achieve the same function with the logic level contrary to the illustrated embodiments.

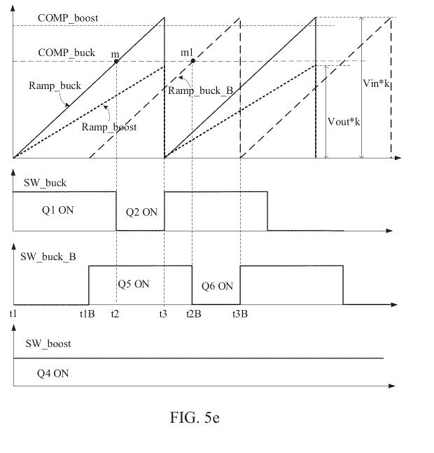

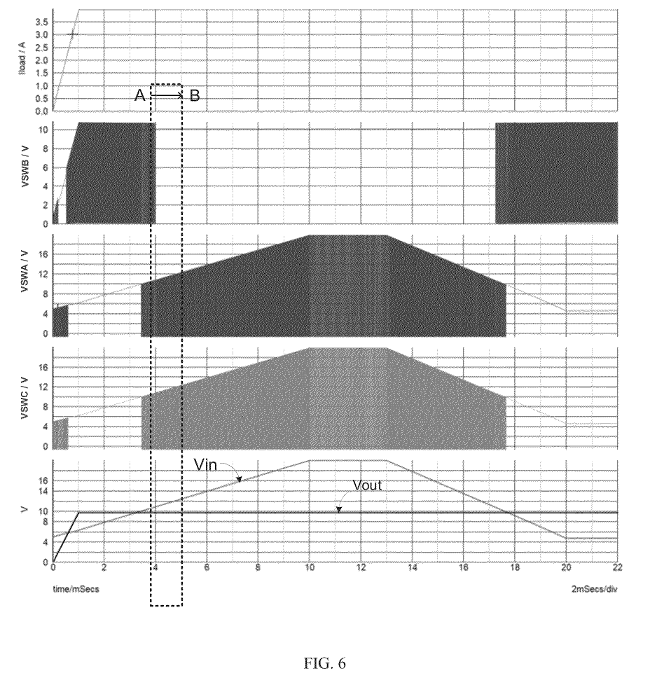

FIG. 6 shows working waveform of the DC-DC converter 10A in accordance with an embodiment of the present invention. As shown in FIG. 6, the input voltage Vin increases from 5V to 20V, then decreases to 5V. The output voltage Vout is kept at 10V after being regulated.

In the embodiment shown in FIG. 6, when the output voltage Vout is regulated in 10V and the input voltage Vin is less than and is not approaching the output voltage Vout, the first pulse width modulation signal SW_buck and the third pulse width modulation signal SW_buck_B are kept in logic high. The high-side switches Q1 and Q5 are kept on, the first-leg node SWA of the first-leg portion 11 and the third-leg node SWC of the third-leg portion 33 are coupled to the input voltage Vin. A voltage VSWA at the first-leg node SWA and a voltage VSWC at the third-leg node SWC both increase from 5V to follow the input voltage Vin. The second pulse width modulation signal SW_boost controls the switches Q4 and Q3 of the second-leg portion 22 switching, the low-side switch Q3 and the high-side switch Q4 work complementarily. The second-leg node SWB is selectively coupled to the output voltage Vout or the reference ground. A voltage VSWB at the second-leg node SWB changes between the output voltage Vout and zero.

Referring still to FIG. 6, when the input voltage Vin is higher than and is not approaching the output voltage Vout, the second pulse width modulation signal SW_boost is kept at logic high. The high-side switch Q4 is kept on, the second-leg node SWB is coupled to the output voltage Vout. The first pulse width modulation signal SW_buck controls the first-leg portion 11 switching, the high-side switch Q1 and the low-side switch Q2 work complementarily. The third pulse width modulation signal SW_buck_B controls the third-leg portion 33 switching, the high-side switch Q5 and the low-side switch Q6 work complementarily. The first-leg node SWA and the third-leg node SWC are selectively coupled to the input voltage Vin or the reference ground. The voltage VSWA at the first-leg node SWA and the voltage VSWC at the third-leg node SWC change between the input voltage Vin and zero.

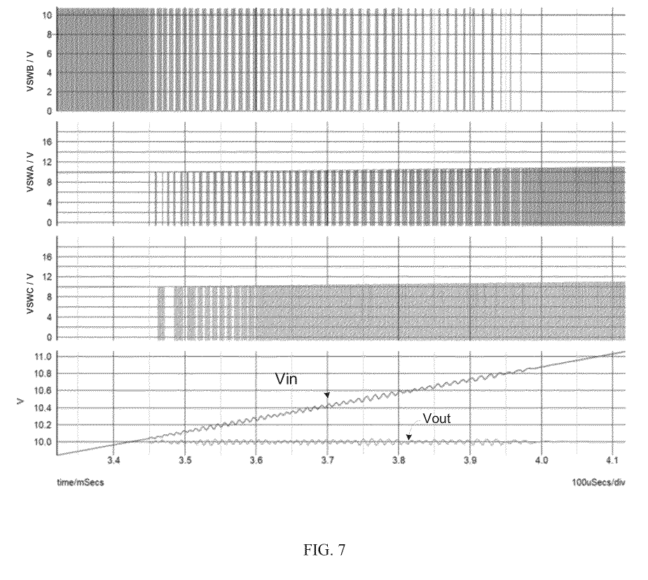

Furthermore, during a time period from A to B shown in FIG. 6, the input voltage Vin approaches the output voltage Vout. FIG. 7 shows a zoom-in view of the working waveforms during the time period from A to B shown in FIG. 6 in accordance with an embodiment of the present invention.

In one switching cycle as BUCK mode, the second pulse width modulation signal SW_boost is kept at logic high. The voltage VSWB is substantially equal to the output voltage Vout, the first-leg node SWA is selectively coupled to the input voltage Vin or the reference ground.

In another switching cycle as BOOST mode, the first pulse width modulation signal SW_buck is kept at logic high. The voltage VSWA is substantially equal to the input voltage Vin, the second-leg node SWB is selectively coupled to the output voltage Vout or the reference ground. It should be noted that, in a single switching cycle, the first pulse width modulation signal SW_buck or the second pulse width modulation signal SW_boost is kept at logic high.

In accordance with an exemplary embodiment of the present invention, the first pulse width modulation signal SW_buck, the second pulse width modulation signal SW_boost, the third pulse width modulation signal SW_buck_B can achieve seamless, automotive and continuous transition to work either in the BUCK mode or in the BOOST mode, to meet the demand of wide input voltage range. It not only improves the efficiency of the system, but also saves circuit costs and improves system performance.

FIG. 8 shows partial circuit diagram of the control circuit 104C in accordance with an embodiment of the present invention. Compared with FIG. 4, the control circuit 104C in FIG. 8 further comprise a controlled current source 55. The controlled current source 55 has an input terminal , a first and second output node. The input terminal of the controlled current source 55 is configured to receive the difference Ier between a first average signal IL1_avg of the first current IL1 and a second average signal IL2_avg of the second current IL2, the controlled current source 55 provides a third current Icomp flowing between the first output node and the second output node to adjust the rising slope of the first ramp signal Ramp_buck and a rising slope of the third ramp signal Ramp_buck_B. As shown in FIG. 8, the first output node of the controlled current source 55 is coupled to the third capacitor C3, the second output node of the controlled current source 55 is coupled to the first capacitor C1.

In one embodiment, the controlled current source 55 comprises a voltage-controlled current source. In another embodiment, the controlled current source 55 comprises a current-controlled current source.

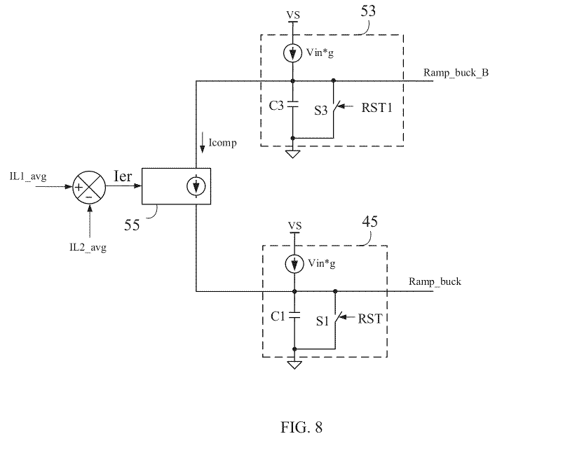

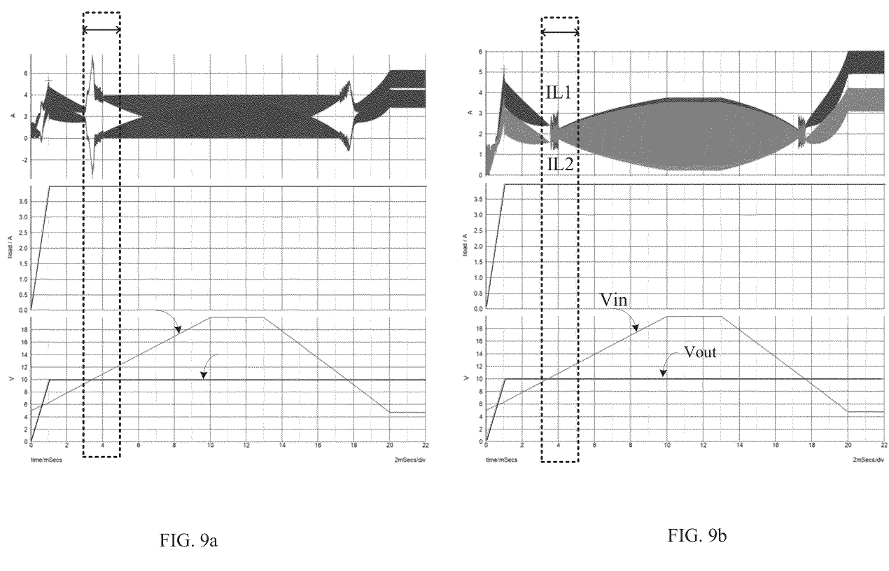

FIG. 9a and 9b respectively show working waveforms of the DC-DC converter without and with a controlled current source 55 in accordance with an embodiment of the present invention. Before the controlled current source 55 is introduced into the DC-DC converter, as shown in FIG. 9a, the control circuit 104B lacks the current balance function, the working waveforms of the DC-DC converter without the controlled current source 55 is shown in FIG. 9a. After introducing the controlled current source 55, the working waveforms of the DC-DC converter with the controlled current source 55 is shown in FIG. 9b. It can be seen from a time period from C to D, the difference between the first current IL1 and the second current IL2 is decreased quickly, and thus the current balance is good.

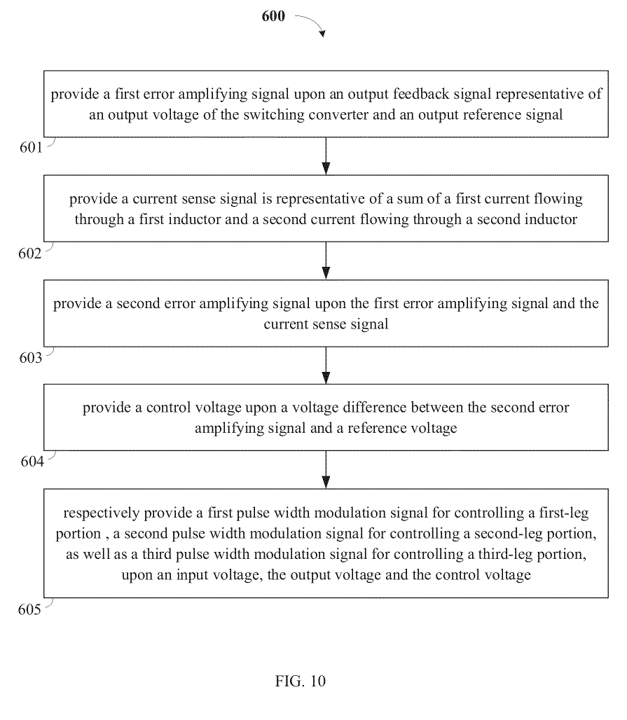

FIG. 10 shows a flow diagram of a control method 600 used in a DC-DC converter in accordance with an embodiment of the present invention. The control method 600 comprises steps 601~605. The DC-DC converter has a first-leg portion, a second-leg portion, a third-leg portion, as well as a first inductor and a second inductor.

In step 601, a first error amplifying signal is provided based upon an output feedback signal representative of an output voltage of the DC-DC converter and an output reference signal.

In step 602, a current sense signal is provided and is representative of a sum of a first current flowing through the first inductor and a second current flowing through the second inductor.

In step 603, a second error amplifying signal is provided based upon the first error amplifying signal and the current sense signal.

In step 604, a control voltage is generated based upon a voltage difference between the second error amplifying signal and a reference voltage.

In step 605, a first pulse width modulation signal is provided to control the first-leg portion, a second pulse width modulation signal is provided to control the second-leg portion, and a third pulse width modulation signal is provided to control the third-leg portion, based upon an input voltage, the output voltage and the control voltage.

In one embodiment, a first-leg node of the first-leg portion is selectively coupled to the input voltage or a reference ground based on the first pulse width modulation signal, and the first-leg node is coupled to a first terminal of the first inductor, a second-leg node of the second-leg portion is selectively coupled to the output voltage or the reference ground based on the second pulse width modulation signal, and the second-leg node is coupled to a second terminal of the first inductor and a first terminal of the second inductor, a third-leg node of the third-leg portion is selectively coupled to the input voltage or the reference ground based on the third pulse width modulation signal, and the third-leg node is coupled to the second terminal of the second inductor.

In another embodiment, the control method 600 further comprises: the first pulse width modulation signal and the second pulse width modulation signal are paused, the first-leg portion and the second-leg portion stop switching, in response to the first error amplifying signal decreasing to be less than a first threshold voltage. Subsequently, the first pulse width modulation signal and the second pulse width modulation signal are resumed and transmitted to the first-leg portion and the second-leg portion for a conversion process, the first-leg portion and the second-leg portion start switching, in response to the first error amplifying signal increasing to higher than the first threshold voltage.

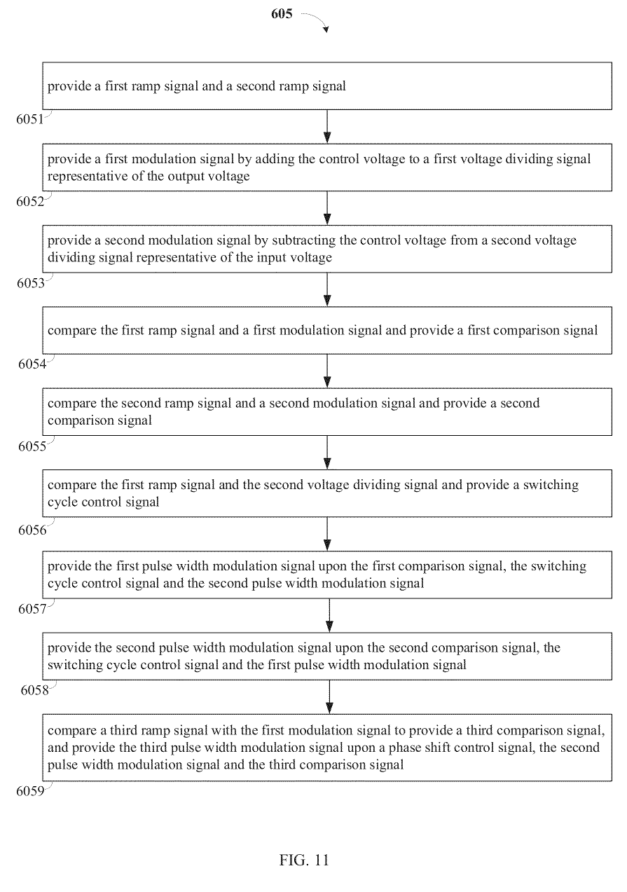

FIG. 11 shows a flow diagram of a step 605 shown in FIG. 10 in accordance with an embodiment of the present invention. As shown in FIG. 11, the step 605 may comprise the steps 6051~6059.

In step 6051, a first ramp signal and a second ramp signal are provided. A rising slope of the first ramp signal is in a first proportion to the input voltage, and a rising slope of the second ramp signal is in the first proportion to the output voltage.

In step 6052, a first modulation signal is generated by adding the control voltage to a first voltage dividing signal representative of the output voltage.

In step 6053, a second modulation signal is generated by subtracting the control voltage from a second voltage dividing signal representative of the input voltage.

In step 6054, the first ramp signal is compared with the first modulation signal to provide a first comparison signal.

In step 6055, the second ramp signal is compared with the second modulation signal to provide a second comparison signal.

In step 6056, a switching cycle control signal is provided by comparing the first ramp signal with the second voltage dividing signal. In an example, the first ramp signal, the second ramp signal and the switching cycle control signal are in phase.

In step 6057, the first pulse width modulation signal is generated based upon the first comparison signal, the switching cycle control signal and the second pulse width modulation signal.

In step 6058, the second pulse width modulation signal is generated based upon the second comparison signal, the switching cycle control signal and the first pulse width modulation signal.

In step 6059, a third comparison signal is provided by comparing a third ramp signal with the first modulation signal, and the third pulse width modulation signal is provided based upon a phase shift control signal, the second pulse width modulation signal and the third comparison signal. The phase shift control signal is 180º out of phase with the switching cycle control signal. The third ramp signal is 180º out of phase with the first ramp signal.

In an example, a first average signal of the first current is provided, and a second average signal of the second current is also provided. The rising slope of the first ramp signal and a rising slope of the third ramp signal are adjusted based upon the difference between the first average signal and the second average signal.

It is to be understood that “substantially” is a term of art, and is meant to convey the principle that relationship such simultaneity or perfect synchronization cannot be met with exactness, but only within the tolerances of the technology available to a practitioner of the art under discussion.

In this document, relational terms such as first and second, and the like may be used solely to distinguish one entity or action from another entity or action without necessarily requiring or implying any actual such relationship or order between such entities or actions. Numerical ordinals such as “first,” “second,” “third,” etc. simply denote different singles of a plurality and do not imply any order or sequence unless specifically defined by the claim language. The sequence of the text in any of the claims does not imply that process steps must be performed in a temporal or logical order according to such sequence unless it is specifically defined by the language of the claim. The process steps may be interchanged in any order without departing from the scope of the invention as long as such an interchange does not contradict the claim language and is not logically nonsensical.

Obviously, many modifications and variations of the present invention are possible in light of the above teachings. It is therefore to be understood that within the scope of the appended claims the invention may be practiced otherwise than as specifically described. It should be understood, of course, the foregoing disclosure relates only to a preferred embodiment (or embodiments) of the invention and that numerous modifications may be made therein without departing from the spirit and the scope of the invention as set forth in the appended claims. Various modifications are contemplated, and they obviously will be resorted to by those skilled in the art without departing from the spirit and the scope of the invention as hereinafter defined by the appended claims as only a preferred embodiment(s) thereof has been disclosed.

What is claimed is:

1. A DC-DC converter, comprising:
a first-leg portion with a first-leg node configured to be coupled to a first terminal of a first inductor;
a second-leg portion with a second-leg node configured to be coupled to a second terminal of the first inductor and a first terminal of a second inductor;
a third-leg portion with a third-leg node configured to be coupled to a second terminal of the second inductor;
a first error amplifying circuit configured to receive an output feedback signal representative of an output voltage of the DC-DC converter and to provide a first error amplifying signal based upon the output feedback signal and an output reference signal;
a second error amplifying circuit configured to receive the first error amplifying signal and a current sense signal to provide a second error amplifying signal, wherein the current sense signal is representative of a sum of a first current flowing through the first inductor and a second current flowing through the second inductor;
a control voltage generator configured to provide a control voltage based upon the second error amplifying signal and a reference voltage; and
a pulse width modulation circuit configured to respectively control the first-leg portion, the second-leg portion, and the third-leg portion based upon an input voltage, the output voltage and the control voltage.

2. The DC-DC converter of claim 1, wherein the pulse width modulation circuit comprises:
a first modulation signal generator configured to provide a first modulation signal by adding the control voltage to a first voltage dividing signal representative of the output voltage;
a second modulation signal generator configured to provide a second modulation signal by subtracting the control voltage from a second voltage dividing signal representative of the input voltage;
a switching cycle control circuit configured to provide a switching cycle control signal;
a first modulation circuit configured to provide a first pulse width modulation signal for controlling the first-leg portion, based on the switching cycle control signal, a first ramp signal and the first modulation signal; and
a second modulation circuit configured to provide a second pulse width modulation signal for controlling the second-leg portion, based on the switching cycle control signal, a second ramp signal and the second modulation signal.

3. The DC-DC converter of claim 2, the pulse width modulation circuit further comprises:
a first ramp signal generator configured to provide the first ramp signal, comprising:
a first current source configured to provide a first charging current for charging a first capacitor; and
a first discharge switch configured to discharge the first capacitor based upon the switching cycle control signal; and
a second ramp signal generator configured to provide the second ramp signal, comprising:
a second current source configured to provide a second charging current for charging a second capacitor; and
a second discharge switch configured to discharge the second capacitor based upon the switching cycle control signal.

4. The DC-DC converter of claim 2, wherein a rising slope of the first ramp signal is proportional to the input voltage, and a rising slope of the second ramp signal is proportional to the output voltage.

5. The DC-DC converter of claim 2, wherein the pulse width modulation circuit further comprises:
a phase shift control circuit configured to provide a phase shift control signal;
a third ramp signal generator configured to provide a third ramp signal; and
a third modulation circuit configured to provide a third pulse width modulation signal for controlling the third-leg portion, based on the phase shift control signal, the third ramp signal and the first modulation signal.

6. The DC-DC converter of claim 5, further comprising:
a controlled current source having an input terminal, a first output node and a second output node, wherein the input terminal of the controlled current source is configured to receive the difference between a first average signal of the first current and a second average signal of the second current, the controlled current source provides a third current flowing between the first output node and the second output node, to adjust a rising slope of the first ramp signal and a rising slope of the third ramp signal.

7. The DC-DC converter of claim 1, wherein:
the first-leg node is configured to be selectively coupled to the input voltage or a reference ground;
the second-leg node is configured to be selectively coupled to the output voltage or the reference ground; and
the third-leg node is configured to be selectively coupled to the input voltage or the reference ground.

8. A control circuit for a DC-DC converter with a first-leg portion, a second-leg portion and a third-leg portion, comprising:
a first error amplifying circuit configured to receive an output feedback signal representative of an output voltage of the DC-DC converter and to provide a first error amplifying signal based upon the output feedback signal and an output reference signal;
a second error amplifying circuit configured to receive the first error amplifying signal and a current sense signal to provide a second error amplifying signal, wherein the current sense signal is representative of a sum of a first current flowing through a first inductor of the DC-DC converter and a second current flowing through a second inductor of the DC-DC converter;
a control voltage generator configured to provide a control voltage based upon the second error amplifying signal and a reference voltage; and
a pulse width modulation circuit configured to control the first-leg portion, the second-leg portion, and the third-leg portion, respectively, based upon an input voltage, the output voltage and the control voltage.

9. The control circuit of claim 8, wherein the pulse width modulation circuit comprising:
a first modulation signal generator configured to provide a first modulation signal by adding the control voltage to a first voltage dividing signal representative of the output voltage;
a second modulation signal generator configured to provide a second modulation signal by subtracting the control voltage from a second voltage dividing signal representative of the input voltage;
a switching cycle control circuit configured to provide a switching cycle control signal;
a first modulation circuit configured to provide a first pulse width modulation signal for controlling the first-leg portion, based on the switching cycle control signal, a first ramp signal and the first modulation signal; and
a second modulation circuit configured to provide a second pulse width modulation signal for controlling the second-leg portion, based on the switching cycle control signal, a second ramp signal and the second modulation signal.

10. The control circuit of claim 9, wherein the pulse width modulation circuit further comprises:
a first ramp signal generator for providing the first ramp signal, comprising:
a first current source configured to provide a first charging current for charging a first capacitor; and
a first discharge switch configured to discharge the first capacitor based upon the switching cycle control signal; and
a second ramp signal generator for providing the second ramp signal, comprising:
a second current source configured to provide a second charging current for charging a second capacitor; and
a second discharge switch configured to discharge the second capacitor based upon the switching cycle control signal.

11. The control circuit of claim 9, wherein the pulse width modulation circuit further comprises:
a phase shift control circuit configured to provide a phase shift control signal;
a third ramp signal generator configured to provide a third ramp signal; and
a third modulation circuit configured to provide a third pulse width modulation signal for controlling the third-leg portion, based upon the phase shift control signal, the third ramp signal and the first modulation signal.

12. The control circuit of claim 9, wherein a rising slope of the first ramp signal is proportional to the input voltage, and a rising slope of the second ramp signal is proportional to the output voltage.

13. The control circuit of claim 8, further comprising:
a controlled current source having an input terminal, a first output node and a second output node, wherein the input terminal of the controlled current source is configured to receive the difference between a first average signal of the first current and a second average signal of the second current, and the controlled current source provides a third current flowing between the first output node and the second output node, to adjust a rising slope of the first ramp signal and a rising slope of the third ramp signal.

14. The control circuit of claim 8, wherein:
a first-leg node of the first-leg portion is coupled to a first terminal of the first inductor;
a second-leg node of the second-leg portion is coupled to a second terminal of the first inductor and a first terminal of the second inductor; and
a third-leg node of the third-leg portion is coupled to a second terminal of the second inductor.

15. A control method used in a DC-DC converter, comprising:
providing a first error amplifying signal based upon an output feedback signal representative of an output voltage of the DC-DC converter and an output reference signal;
providing a current sense signal representative of a sum of a first current flowing through a first inductor of the DC-DC converter and a second current flowing through a second inductor of the DC-DC converter;
providing a second error amplifying signal based upon the first error amplifying signal and the current sense signal;
providing a control voltage based upon the second error amplifying signal and a reference voltage; and
controlling a first-leg portion, a second-leg portion and a third-leg portion of the DC-DC converter, respectively, based upon an input voltage, the output voltage and the control voltage.

16. The control method of claim 15, wherein further comprising:
providing a first modulation signal by adding the control voltage to a first voltage dividing signal representative of the output voltage;
providing a second modulation signal by subtracting the control voltage from a second voltage dividing signal representative of the input voltage;
comparing a first ramp signal with the first modulation signal to provide a first comparison signal;
comparing a second ramp signal with the second modulation signal to provide a second comparison signal;
comparing the first ramp signal with the second voltage dividing signal to provide a switching cycle control signal;
providing a first pulse width modulation signal for controlling the first-leg portion based upon the first comparison signal, the switching cycle control signal and a second pulse width modulation signal; and
providing the second pulse width modulation signal for controlling the second-leg portion based upon the second comparison signal, the first pulse width modulation signal and the switching cycle control signal.

17. The control method of claim 16, wherein further comprising:
providing a phase shift control based upon the switching cycle control signal;
comparing a third ramp signal with the first modulation signal to provide a third comparison signal; and
providing a third pulse width modulation signal for controlling the third-leg portion based upon the phase shift control signal, the second pulse width modulation signal and the third comparison signal.

18. The control method of claim 17, wherein:
providing a first average signal of the first current;
providing a second average signal of the second current; and
adjusting a rising slope of the first ramp signal and a rising slope of the third ramp signal, based upon the difference between the first average signal and the second average signal.

19. The control method of claim 16, wherein a rising slope of the first ramp signal is proportional to the input voltage, and a rising slope of the second ramp signal is proportional to the output voltage.

20. The control method of claim 15, wherein:
a first-leg node of the first-leg portion is configured to be selectively coupled to the input voltage or a reference ground, and the first-leg node is coupled to a first terminal of the first inductor;
a second-leg node of the second-leg portion is configured to be selectively coupled to the output voltage or the reference ground, and the second-leg node is coupled to a second terminal of the first inductor and a first terminal of the second inductor; and
a third-leg node of the third-leg portion is configured to be selectively coupled to the input voltage or the reference ground, and the third-leg node is coupled to the second terminal of the second inductor.
